(19) United States
(12) Patent Application Publication
(10) Pub. No.: US 2015/0203080 A1
(43) Pub. Date: Jul. 23, 2015

(54) METHOD AND APPARATUS FOR CONTROLLING MOBILITY OF A TROLLEY

(71) Applicant: Shivani Scientific Industries Private Limited, Mumbai (IN)

(72) Inventors: Ashish MODI, Mumbai (IN); Ravikant KALE, Mumbai (IN)

(21) Appl. No.: 14/601,934

(22) Filed: Jan. 21, 2015

(30) Foreign Application Priority Data
Jan. 23, 2014 (IN) 244/MUM/2014

(51) Int. Cl. B60T 1/14

(52) U.S. Cl. CPC B60T 1/14

(57) ABSTRACT

Disclosed is a method and apparatus for controlling mobility of a trolley. The apparatus may be attached to the trolley at the bottom. The apparatus may comprise an anti-skid surface and a controlling means to control the movement of the anti-skid surface. The anti-skid surface may be enabled to move vertically downward and upward, via the controlling means, thereby arresting mobility of the trolley. The downward movement of the anti-skid surface may facilitate contact between the anti-skid surface and floor thereby arresting the mobility, whereas the upward movement of the anti-skid surface may restore the mobility by disconnecting the contact between the anti-skid surface and the floor.

### CROSS-REFERENCE TO RELATED APPLICATIONS AND PRIORITY

The present application claims priority from Indian patent application 244/MUM/2014 filed on Jan. 23, 2014, the entirety of which is hereby incorporated by reference.

### TECHNICAL FIELD

The present disclosure described herein, in general, relates to an apparatus for mobility control, and more particularly to the apparatus for mobility control of mobile equipments like a trolley, a carriage, and a hand pulled wagon.

### BACKGROUND

Mobile equipments like hand pulled carriages, trolleys or wheel attached wagons are generally used to carry light weight load to a desired place. Further, the mobile equipments are generally seen in laboratories, hospitals, offices or similar places. While handling such mobile equipments, more care and caution has to be taken due to swift moving or turning nature of the mobile equipments due to wheels attached at the bottom. The swift movement and the turning of mobile equipment may harm both an operator and patient when such mobile equipment is used in medical field to carry medical devices or apparatuses.

In the medical field, different mobile medical equipments are used for carrying various instruments, and materials associated with medical operations. These mobile equipments often have to be moved from one location to the other during performing the medical operations. These mobile medical equipments are generally equipped with a braking or locking/arresting mechanisms, via which, mobility of these mobile medical equipments may be controlled. Specifically, during performing any operation, a doctor may utilize the braking and/or locking/arresting mechanism to control the movement of specific mobile medical equipment while proceeding with desired operations. In one example, in order to control the mobility of the mobile medical equipments, the doctor may utilize wheel brakes employed on these equipments. More particularly, the doctor may engage and/or disengage the wheel brakes for enabling the wheels into either locked (arrested)/unlocked (mobile) position.

In a typical situation, the doctor who is performing the medical operations has his/her both hands occupied in holding surgical instruments, and/or performing activities associated with the medical operations. Further, he/she may be constantly observing an ultrasound monitor in order to obtain some guidance pertaining to internal organs of the patient's body. The doctor's vision should not be ideally interrupted while observing the ultrasound monitor in order to diagnose the patient appropriately. Since, the doctor is busy in performing the said activities, it would be a challenge for the doctor to timely engage and/or disengage the wheel brakes in order to control the mobility of the mobile medical equipment.

Therefore, a great amount of skill is required by the doctor in order to simultaneously perform the acts of controlling the mobility of the mobile medical equipment and performing the medical operations, such that the mobile medical equipment does not skid over the floor surface and none of the activities associated to the medical operations are impacted due to the mobility of the mobile medical equipments. Therefore, it is required to provide the doctor an easy, hassle-free and intuitive control over the mobility of the mobile medical equipment such that the activities associated to the medical operations are constantly performed and are not interrupted due to manual intervention of the doctor to control the mobility of the mobile medical equipment.

### SUMMARY

Before the present apparatus(s), method(s) and enablement are described, it is to be understood that this disclosure in not limited to the particular apparatuses and methodologies described, as there can be multiple possible embodiments of the present disclosure and which are not expressly illustrated in the present disclosure. It is also to be understood that the terminology used in the description is for the purpose of describing the particular versions or embodiments only, and is not intended to limit the scope of the present disclosure.

In accordance with an embodiment, the present disclosure discloses an apparatus, coupled with a trolley, for controlling mobility of the trolley. The apparatus comprises an anti-skid surface attached at the bottom of the trolley. The anti-skid surface may be moved vertically downward and upward using a controlling means. In an embodiment, the downward movement may facilitate the anti-skid surface to make contact with the floor thereby arresting the mobility of the trolley. Alternatively, the upward movement disconnects the contact of the anti-skid surface with the floor thereby restoring the mobility of the trolley.

In another embodiment, a method for controlling mobility of a trolley is disclosed. The method may comprise moving an anti-skid surface vertically downward and upward using a controlling means. In an embodiment, the downward movement may facilitate the anti-skid surface to make contact with the floor thereby arresting the mobility of the trolley. Alternatively, the downward movement disconnects the contact of the anti-skid surface with the floor thereby restoring the mobility of the trolley.

### BRIEF DESCRIPTION OF THE DRAWINGS

The detailed description is described with reference to the accompanying figure. In the figure, the left-most digit(s) of a reference number identifies the figure in which the reference number first appears. The same numbers are used throughout the drawing to refer like features and components.

FIG. 1 illustrates a diagram 100 of a trolley (bottom view) fitted with an apparatus therein for controlling mobility of the trolley, in accordance with an embodiment of the present subject matter.

FIGS. 2(a) and 2(b) illustrates side view of the trolley fitted with the apparatus therein for controlling mobility of the trolley in mobile (FIG. 2(a)) and arrested (FIG. 2(b)) positions, in accordance with an embodiment of the present disclosure.

FIGS. 3(a) and 3(b) illustrates a controlling means in form of a cross-leg assembly in mobile (FIG. 3(a)) and arrested (FIG. 3(b)) positions, in accordance with an embodiment of the present disclosure.

FIGS. 4(a) and 4(b) illustrates a controlling means in form of pressure cylinders in mobile (FIG. 4(a)) and arrested (FIG. 4(b)) position, in accordance with an embodiment of the present disclosure.

### DETAILED DESCRIPTION

The exemplary embodiments of the present disclosure are described herein in detail, though the present disclosure is not limited to these embodiments. Constituting elements in the embodiments include elements easily achieved by a person skilled in the art, or elements being substantially equivalent to those elements.

The words “comprising”, “having”, “containing”, and “including”, and other forms thereof, are intended to be equivalent in meaning and be open ended in that an item or items following any one of these words is not meant to be an exhaustive listing of such item or items, or meant to be limited to only the listed item or items. It must also be noted that as used herein, the singular forms “a”, “an”, and “the” include plural references unless the context clearly dictates otherwise.

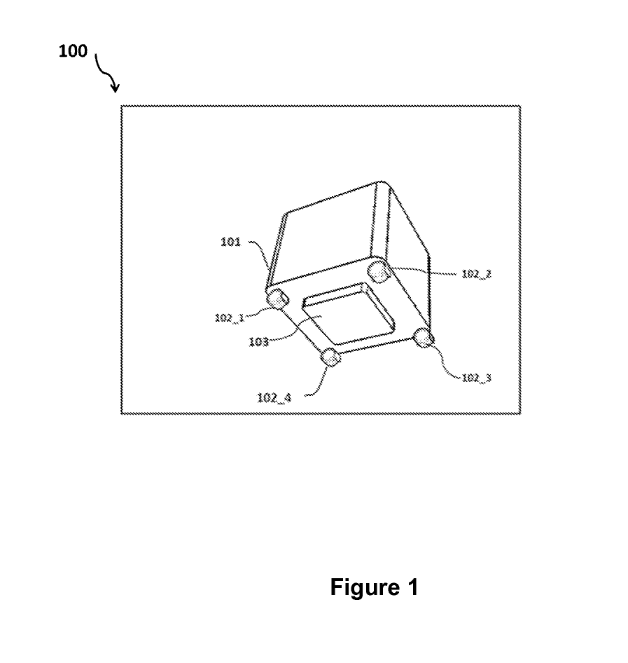

According to embodiments of present disclosure, an apparatus, more specifically electrically operated apparatus for controlling mobility of the trolley is disclosed. The apparatus may comprise components like an anti-skid surface and a controlling means to move the anti-skid surface vertically upward and downward. The apparatus may be attached at the bottom of the trolley. The apparatus when triggered, using the controlling means, may actuate the anti-skid surface to arrest the position of the trolley by making surface contact of the anti-skid surface with the floor. Further, the anti-skid surface may be moved slightly upward to disconnect the contact of the anti-skid surface with the floor, thereby restoring the mobility of the trolley. Further the apparatus is explained in detail using a FIG. 1 in the following description.

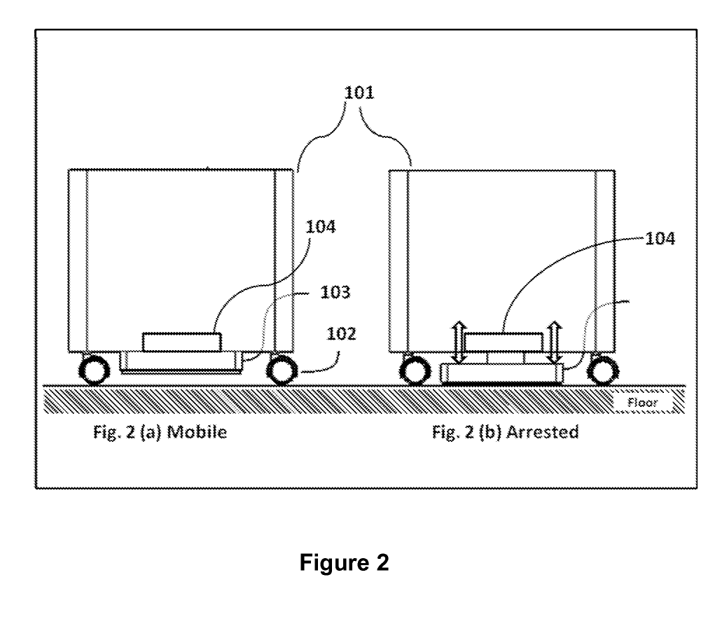

Now referring to the FIG. 1, the apparatus attached to the trolley 101 at the bottom is shown. In an embodiment, the trolley 101 resting on wheels 102 (referred to as 102_1, 102_2, 102_3, and 102_4) is shown in the FIG. 1. The FIG. 1 illustrates bottom view of the trolley. In one embodiment, the apparatus may be controlled by the controlling means (not shown in the FIG. 1). The controlling means may further be electrically controlled. The controlling means may enable the anti-skid surface 103 to move vertically upward and downward. The movement of the anti-skid surface may further be explained in detail using a FIG. 2.

Referring to the FIGS. 2(a) and 2(b), the apparatus may comprise the anti skid surface 103 and the controlling means 104 as shown, in accordance with an embodiment of present disclosure. Further, the FIGS. 2(a) and 2(b) illustrates the anti-skid surface 103 positioned in a mobile position and an arrested position respectively. The apparatus may further comprise the controlling means 104 integrated with the trolley 101 from one end and the anti-skid surface 103 from other end. The movement of the anti-skid surface 103 may be achieved through various controlling means such as a cross-leg assembly, a pressure cylinder, or a spring operated means. These controlling means may be explained in various embodiments as below.

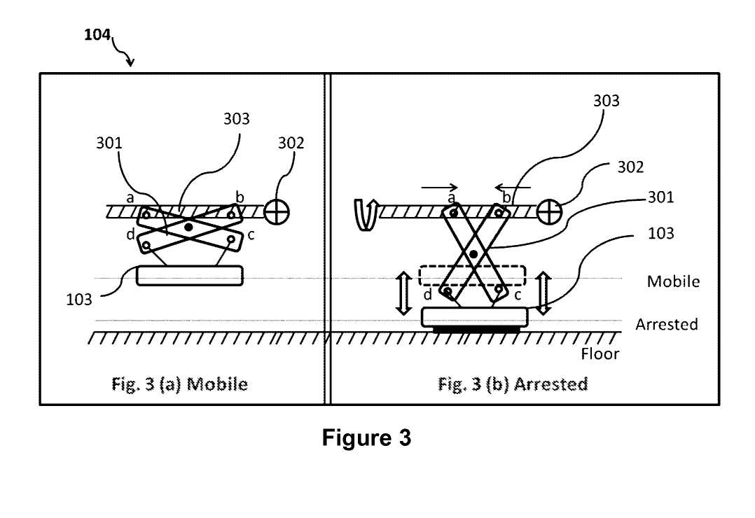

In one embodiment, the controlling means 104 may comprise a cross-leg assembly 301, a motor 302 and a ball-screw actuator 303 as shown in FIGS. 3(a) and 3(b) in mobile (FIG. 3(a)) and arrested (FIG. 3(b)) positions. The cross-leg assembly 301 may further comprise a pair of legs, hinged together at the centre. The four corners of the cross-leg assembly may be referred to as ‘a’, ‘b’, ‘c’ and ‘d’ in clock-wise direction. Furthermore, the ball-screw actuator 303 may be adapted to join the corner ‘a’ with ‘b’. The motor 302 may be adapted to rotate the ball-screw actuator 303 through desired angle. In an embodiment, the motor 302 may be triggered ON and OFF using an electrical switch operated by an operator of the trolley. When the motor 302 is ON, the ball-screw actuator 303 may be enabled to rotate through desired angle, thereby making corners ‘a’ and ‘b’ to come closer to each other or move away from each other, depending upon direction of rotation of the ball-screw actuator 303.

Furthermore, as shown in the FIG. 3, in this embodiment, in one scenario, where the corners ‘a’ and ‘b’ come close to each other due to rotation of the ball-screw actuator 303, the cross-leg assembly 301 may expand and may push the anti-skid surface 103 downwards as shown in FIG. 3(b). In this position, the anti-skid surface 103 may make contact with the floor thereby arresting the mobility of the trolley due to anti-skid material. In another scenario, where the motor 302 may be rotated in reverse direction, the corners ‘a’ and ‘b’ may be moved away from each other thereby restoring the position of the cross-leg assembly 301. Upon restoring the position, the anti-skid surface 103 may be moved upwards thereby disconnecting the contact between the anti-skid surface 103 and the floor as shown in the FIG. 3(a). Furthermore, the cross-leg assembly 301 may be attached at the bottom of the trolley 101.

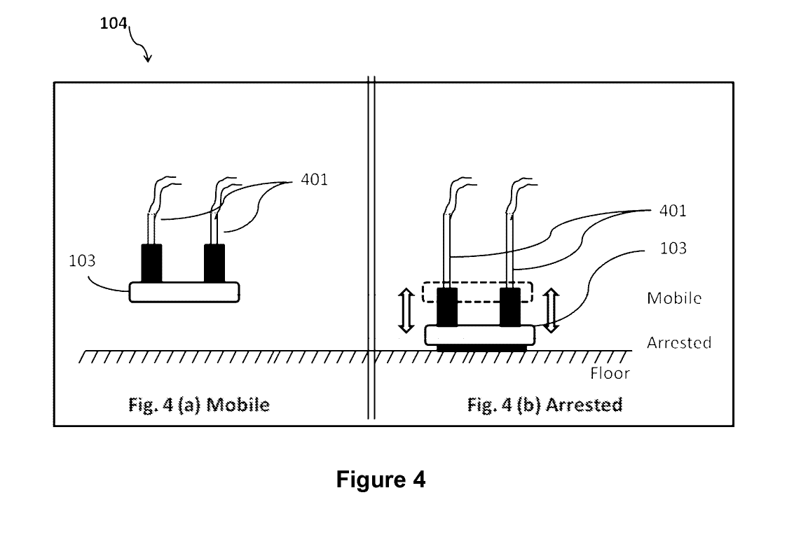

In alternative embodiment, as shown in the FIGS. 4(a) and 4(b), the controlling means 104 may be the pressure cylinder. In some embodiments, the controlling means may comprise a plurality of pressure cylinders as shown in the FIGS. 4(a) and 4(b). In the present embodiment, the plurality of the pressure cylinders 401 may comprise either pneumatically operated or hydraulically operated cylinders. Further, the pressure (pneumatic or hydraulic) may be achieved through pressure source attached to the pressure cylinders 401 through pressure hose. The pressure cylinder 401 may further be attached to the anti-skid surface 103. Upon actuation of the pressure cylinders 401, the antiskid surface 103 may be enabled to move vertically downward due to extended pressure cylinders as shown in the FIG. 4(b). The required amount of the pressure (pneumatic or hydraulic) may be provided to the pressure cylinder in a controlled manner. Hence, mobility of the trolley 101 may be achieved by moving the anti-skid surface 103 downwards. Further, upon releasing the applied pressure, the pressure cylinders 401 may be restored to previous position, thereby disconnecting the contact between the anti-skid surface 103 and the floor as shown in the FIG. 4(a). The controlling means 104 may be attached at the bottom of the trolley 101.

In yet another embodiment, spring tension may be adapted as the controlling means 104. A plurality of springs may be adapted to achieve movement of the anti-skid surface 103. The plurality of springs in compressed position may give mobile position of the trolley. The controlling means 104 may be enabled to de-compress the plurality of springs or release the pressure on the plurality of springs, thereby achieving vertically downwards movement of the anti-skid surface 103 attached to the plurality of springs. The downward movement may result into arresting mobility of the trolley 101. It is to be noted by a person skilled in the art that, the embodiments explained above pertaining to the control means 104 are exemplary and is not intended to be construed as a limitation, and any similar, modified or other controlling means may be adapted to achieve movement of the anti-skid surface 103.

In view of the variety of embodiments of the present disclosure, it will be appreciated that various modifications or changes can be made in the preferred embodiments without departing from the principle of the disclosure. These and other modifications in the nature of the disclosure or the preferred embodiments will be apparent to those skilled in the art from the disclosure herein. It is to be particularly understood that the former descriptive matter is to be interpreted merely as illustrative of the disclosure and not as a limitation.

We claim:

1. An apparatus, coupled with a trolley, for controlling mobility of the trolley comprising an anti-skid surface attached at the bottom of a trolley, wherein the anti-skid surface is moved vertically downward and upward using a controlling means, wherein the downward movement facilitates the anti-skid surface to make contact with the floor thereby arresting the mobility of the trolley, and wherein the upward movement disconnects the contact of the anti-skid surface with the floor thereby restoring the mobility of the trolley.

2. The apparatus of claim 1, wherein the apparatus is coupled at the bottom of the trolley.

3. The apparatus of claim 1, wherein the controlling means is a cross-leg assembly capable of moving the anti-skid surface vertically downward and upward, and wherein the cross-leg assembly comprises a pair of legs attached together through a hinge joint at the centre of the legs, and wherein the legs of the cross-leg assembly are hinged together at the centre.

4. The apparatus of claim 1, wherein the controlling means is at least one pressure operated cylinder capable of moving the anti-skid surface vertically downward and upward.

5. The controlling means of claim 4, wherein the pressure operated cylinder is either pneumatic pressure or hydraulic pressure operated cylinder.

6. The apparatus of claim 1, wherein the controlling means is a spring operated means capable of moving the anti-skid surface vertically downward and upward.

7. The method for controlling mobility of a trolley, comprising: moving an anti-skid surface vertically downward and upward using a controlling means, wherein the downward movement facilitates the anti-skid surface to make contact with the floor thereby arresting the mobility of the trolley, and wherein the upward movement disconnects the contact of the anti-skid surface with the floor thereby restoring the mobility of the trolley.
